(19) United States
(12) Patent Application Publication
(10) Pub. No.: US 2005/0060418 A1
(43) Pub. Date: Mar. 17, 2005

(54) Packet classification

(76) Inventor: Gennady Sorokopud, Netanya (IL)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/666,820

(22) Filed: Sep. 17, 2003

(51) Int. Cl. G06F 15/16

(52) U.S. Cl. 709/230; 370/389

(57) ABSTRACT

Methods (processes) and systems for performing classification of packets utilize processes such as protocol recognition, state-based inspection, decision-making, traffic aggregation, classification events, efficiency in resource utilization, scalability and redundancy. These methods (processes) and systems recognize both standard and non-standard protocols and are able to make classifications in the absence of a precise rule match. By classifying these packets, by one or more of the aforementioned processes, subject to protocol recognition, specific packets can be subjected to individualized processes, for example, routing, shaping, queuing and content processing.

### TECHNICAL FIELD

The present invention is directed to packetized transmissions in cellular networks. In particular, the invention is directed to systems and methods for classifying the packets that make up these packetized transmissions.

### BACKGROUND

Protocol-based communications, such as those involved in wired and wireless networks are currently widely and extensively used. Such networks include cellular mobile data networks, fixed wireless data networks, satellite networks, and networks formed from multiple connected wireless local area networks (LANs). In each network using protocol-based communications, data is transmitted in packets.

These packets were then viewed one packet at a time by classification engines, to see if they were suitable for the particular application to be performed. For example, routing applications required packets to be identified and matched against the entries or rules of the routing table. Also, applications were limited in the number of layers they could accommodate because layer separation could not be performed efficiently, by isolating packets one at a time.

These classification engines were complemented by additional protocol specific modules, that added state based or more complex classifications, when it was required. This was typically done to handle protocols such as Transmission Control Protocol (TCP) and Hypertext Transfer Protocol (HTTP). These modules analyzed the protocol, its fields, and its state, and produced additional information that could not be provided by the basic classifier.

The architecture for these classification engines with the add-on modules was protocol specific and not flexible. As a result, if handling of additional protocols was desired, another add-on for that specific protocol had to be added. In the case of a non-standard protocol, classification simply could not be performed.

### SUMMARY

The present invention provides methods and systems for classification of packets. In this document, the term “classification” includes processes and subprocesses performed on one or more packets. These processes may include protocol recognition, state-based inspection, decision-making, traffic aggregation, classification events, efficiency in resource utilization, scalability and redundancy. By classifiying these packets, specific packets can be subjected to individualized processes, for example, routing, shaping, queueing and content processing.

The present invention recognizes both standard and non-standard protocols and is able to make classifications in the absence of a precise rule match. It is flexible, as it does not use a fixed set or table of rules. For example, if a certain application protocol is used on a non-standard port, the classifier and classification method will be able to recognize it, and assign it a classification tag, as if was on a port corresponding to a standard protocol.

The methods and systems for packet classification described herein, can perform a state based inspection for any protocol associated with a specific flow of packets. The aforementioned methods and systems can then reach a decision as to classification for the requisite packet, based on the detected state. For example, in the case of an Internet Protocol (IP) fragmentation, for successful classification of fragments beyond the first one, packet identifiers (ID) and fragment number have to be recorded. This can be performed by, for example, a generic state inspection mechanism or a dedicated IP fragmentation module.

The methods and systems described herein can be decision-makers for packets that can not be precisely classified. Instead of assigning a default value to these imprecisely classified packets, additional logic is utilized to reach a classification decision based on classification history.

Also described herein, are classification methods and systems for aggregating packets into flows (traffic flows) and sessions based on packet classification. The methods and systems disclosed herein can generate events based on classification of the packets, typically coupled with the state-based inspection. For example, the generated events may include notification about session termination, initiation and expiration.

The methods and systems disclosed herein can utilize resources, such as memory and CPU efficiently in classifiying packets. The methods and systems disclosed herein are of architecture that is scalable. System redundancy can be supported through special synchronization facilities.

An embodiment of the invention is directed to a packet classifier. This packet classifier includes a data structure for storing classification information and a processor. The data structure is contained in a memory and includes a graph including a plurality of nodes connected by at least one edge for corresponding to at least one pattern, the graph configured such that movement between the nodes occurs upon at least one packet matching the at least one pattern. The processor includes program means, for applying at least one packet to the data structure to classify the at least one packet. The graph is configured to accommodate dynamically changing data, and matching includes at least a partial correspondence between the at least one packet and the at least one pattern.

Another embodiment is directed to a method for searching a memory to locate information in a packet classification system. This method includes: structuring the information so that it includes at least one graph including a plurality of nodes connected by at least one edge for corresponding to at least one pattern, the at least one graph configured such that movement between the nodes occurs upon at least one packet matching the at least one pattern; and, electronically searching the information in the memory to classify the at least one packet. In this method, the at least one graph is configured accommodate dynamically changing data. Also, the matching of the at least one packet to the at least one pattern includes at least a partial correspondence between the at least one packet and the at least one pattern.

Another embodiment includes a computer memory storage device. This computer memory storage device is configured to store packet classification data organized in graphs, each graph including a plurality of nodes connected by at least one edge for corresponding to at least one pattern, each graph configured such that movement between the nodes occurs upon at least one packet matching the at least one pattern. Typically, each of the graphs is configured accommodate dynamically changing data. Also, typically, the matching of the at least one packet to the at least one pattern includes at least a partial correspondence between the at least one packet and the at least one pattern.

There is also an embodiment directed to a method for classifying packets. This method includes: providing a graph including a plurality of nodes, connected by at least one edge, and at least one pattern corresponding to at least one edge, the at least one pattern including at least one state definition; applying at least one packet to the graph; and, determining at least one state of the at least one packet, including analyzing at least one previously computed state coupled with the at least one state definition. This method also includes classifying the at least one packet based on the determined state for the at least one packet.

Another embodiment is directed to a packet classifier including: a data structure for storing classification information, the structure contained in a memory and comprising a graph including a plurality of nodes, connected by at least one edge, and at least one pattern corresponding to at least one edge, the at least one pattern including at least one state definition; and, a processor, including program means, for applying at least one packet to the data structure and determining at least one state of the at least one packet by analyzing at least one previously computed state coupled with the at least one state definition. The processor also functions to classify the at least one packet based on the determined state for the at least one packet. The packet classifier also has memory for storing data corresponding to the at least one determined state, such that the graph accommodates dynamically changing data.

Another embodiment is directed to a computer memory storage device, configured to store packet classification data organized in graphs, each graph including a plurality of nodes, connected by at least one edge, and at least one pattern corresponding to at least one edge, the at least one pattern including at least one state definition. The at least one state definition typically includes a plurality of state definitions, and the state definition(s) is/are typically embedded inside the at least one pattern. The computer memory storage device is also configured to store data corresponding to the at least one determined state, such that the graph accommodates dynamically changing data.

Yet another embodiment is directed to a method of searching a memory to locate information in a system for classifying at least one packet. The method includes: structuring the information in a memory such that it includes at least one pattern, including state-based inspection data and aggregation data for at least one packet; and electronically searching the information in a memory to compare at least one packet to the at least one pattern.

Another embodiment is directed to a method of searching a memory to locate information in a system for classifying at least one packet. This method includes, structuring the information in a memory such that it includes at least one pattern, including state-based inspection data and aggregation data for at least one packet; and, electronically searching the information in a memory to compare at least one packet to the at least one pattern. The at least one pattern is for example, included in a Direct Cyclic Graph (DCG), and the at least one pattern includes at least one node and at least one edge. The method also includes, traversing the Direct Cyclic Graph by moving through the at least one pattern, based on the attachment of the at least one pattern to the at least one node or the at least one edge.

Another embodiment is directed to a packet classifier. This packet classifier includes, a data structure for storing classification information, the structure contained in a memory and comprising at least one pattern, including state-based inspection data and aggregation data for at least one packet; and, a processor including program means for searching the data structure to compare at least one packet to the at least one pattern. For example, the at least one pattern is included in a Direct Cyclic Graph, the Direct Cyclic Graph contained in the memory. Additionally, for example, the Direct Cyclic Graph includes a one-to-one correspondence between portions of the Direct Cyclic Graph and the information in the memory.

Still another embodiment is directed to a packet classification system having, a network driver for receiving packets; a classification module in communication with the network driver for classifying packets received from the network driver; an event module in communication with the classification module, the event module for receiving and processing classification data; a signaling module for determining at least one available engine for receiving classified packets, in communication with the event module; and a control module in communication with the signaling module and the classification module for maintaining and providing configuration information and controlling packet classification. The classification module has an algorithm module for processing received packets against a direct cyclic graph (DCG) and a kernel module for controlling packet flow from the network driver to the algorithm module. The event module is designed for creating a communication to the kernel module for controlling packet flow therethrough, and the algorithm module includes at least a pair of queues coupled with the event module, for sending classification data to the event module.

### BRIEF DESCRIPTION OF THE DRAWINGS

Attention is now directed to the drawing figures, where like reference numerals or characters indicate corresponding or like components. In the drawings:

FIG. 1 is a diagram of a Direct Cyclic Graph (DCG) in accordance with an embodiment of the present invention;

FIG. 2 is a diagram of a data structure, for use with the graph of FIG. 1;

FIGS. 3 and 4 are flow diagrams detailing a process in accordance with an embodiment of the present invention, and detail elements of the respective processes in accordance with standard programming conventions;

FIG. 5 is a diagram of an architecture on which embodiments of the present invention are employed;

FIG. 6 is a diagram of a system employing the architecture of FIG. 5; and

FIG. 7 is a diagram of a Direct Cyclic Graph used in the describing the example below.

### DETAILED DESCRIPTION

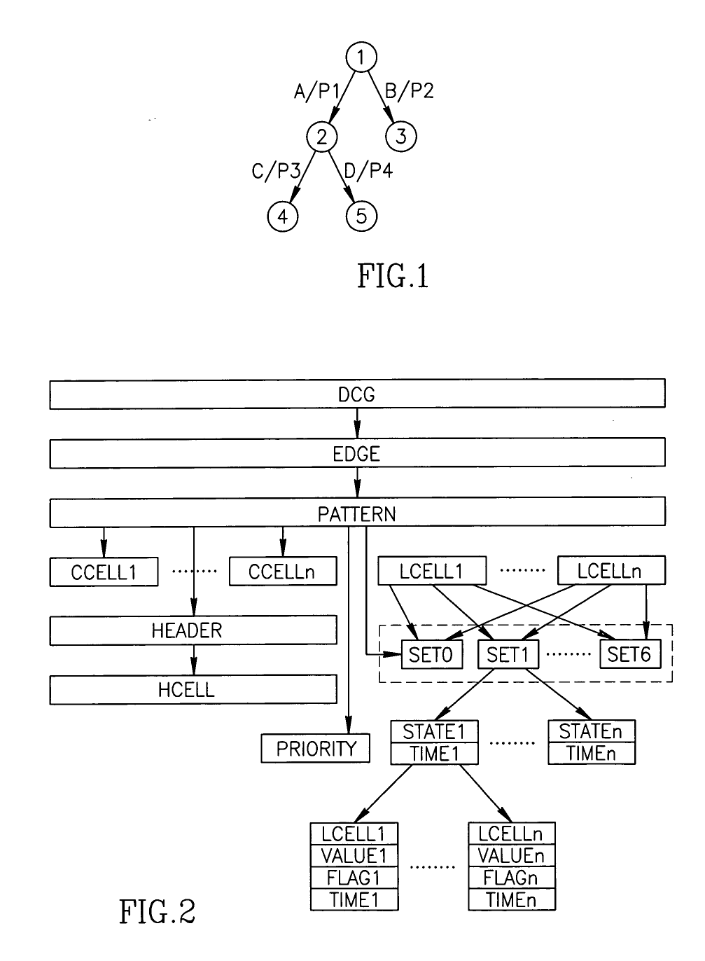

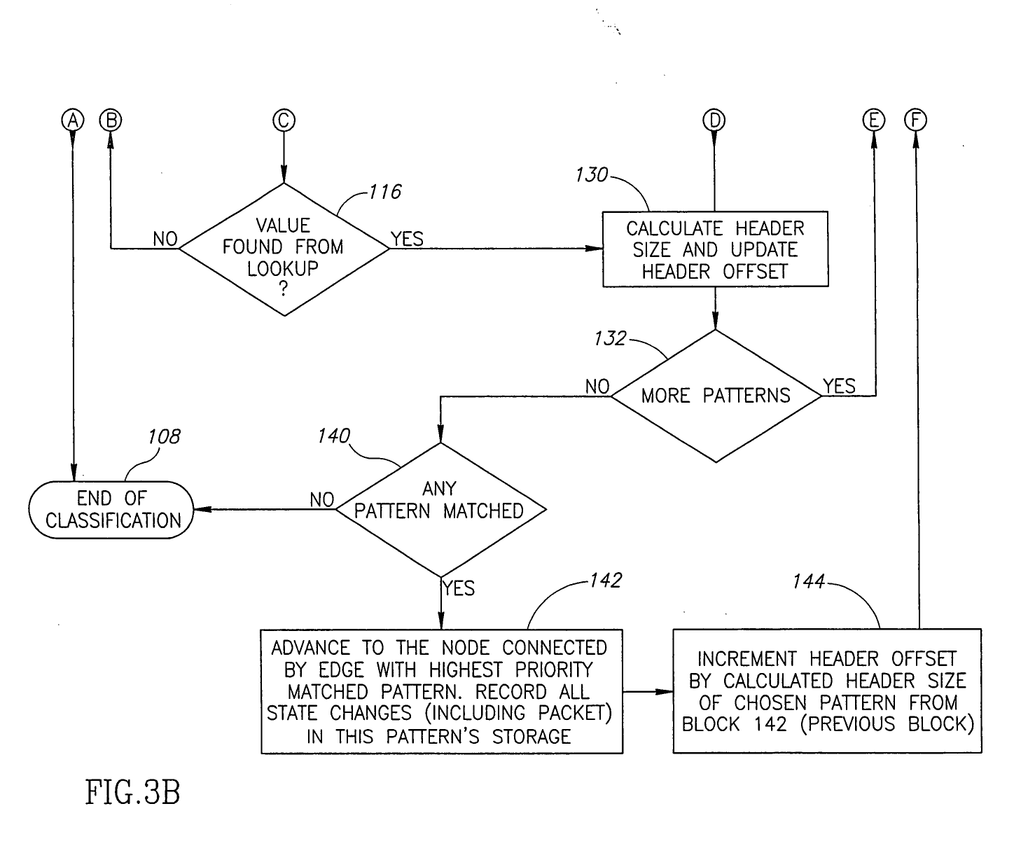

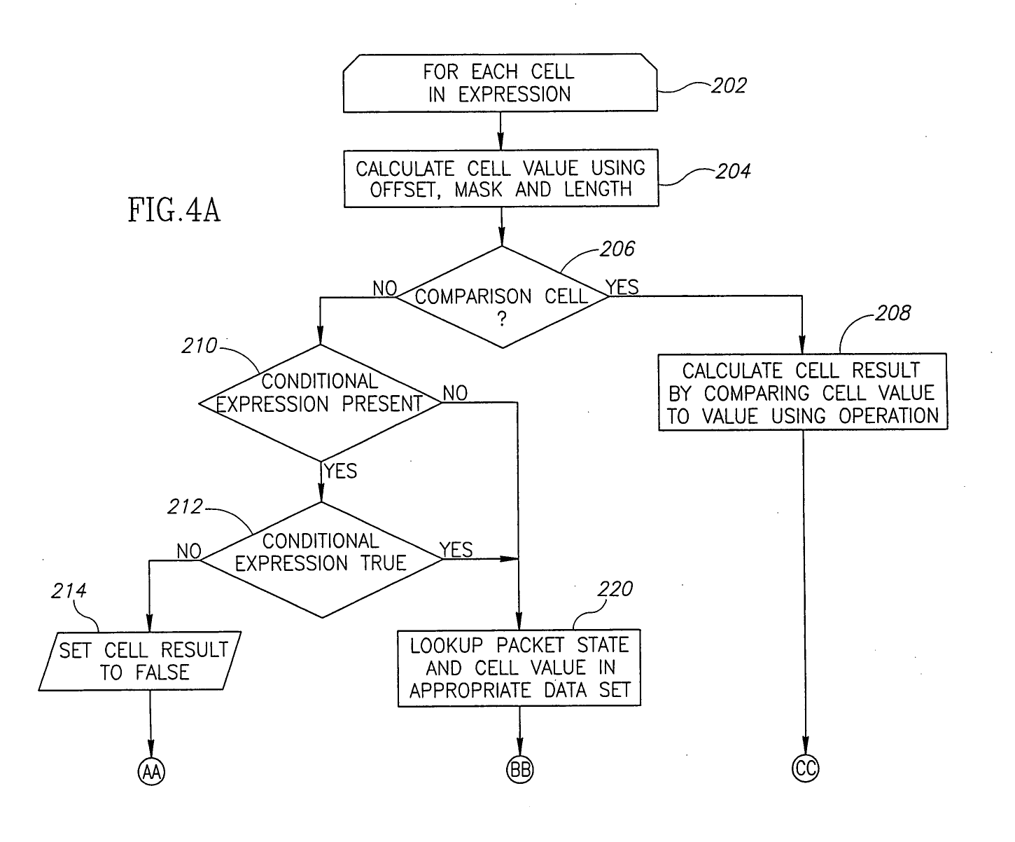

FIG. 1 shows an exemplary data structure representing a Direct Cyclic Graph (DCG), that will be used in describing an exemplary packet classification process in accordance with the invention. This Direct Cyclic Graph (DCG) is used to store all the information related to a classification process, such as that shown in FIGS. 3 and 4 and detailed below. The DCG has interconnected edges and nodes. Each edge of a graph has a special pattern (detailed below) associated with it. Each node has a unique number assigned to it, which is used to represent path in a DCG. When a pattern matches a packet being classified, it means that this DCG can be traversed to the next connecting node.

This DCG is three levels deep, and includes nodes 1-5 joined by connecting edges A-D, with corresponding patterns P1-P4. Throughout the processes, as described herein, each packet is processed against a DCG, similar to that of FIG. 1 and each node is assigned a unique positive number in accordance with the following convention: the root of the graph is Node 1 (the first node), and then all nodes are counted from top to bottom and left to the right sequentially.

Each edge of the DCG has a priority value associated with it. Accordingly, the priority of the edge will also indicate priority of the pattern associated with it. Relative to a specific node, all edges can be classified as incoming edges, outgoing edges, and unrelated edges.

The data structure represented by the DCG is typically such that it is stored/structured in a memory (or other storage media) in a server or other computer type device with associated hardware and/or software. This memory can be electronically searched by suitably programmed hardware, software and the like.

The components of the DCG of FIG. 1 will now be explained as follows.

1.0. Cell. A Cell is the smallest entity used for pattern matching in the DCG. There are two types of cells: comparison cells and loadable cells. The loadable cells can be further broken down into two subtypes, Global Loadable Cells (GLC) and Variable Cells.

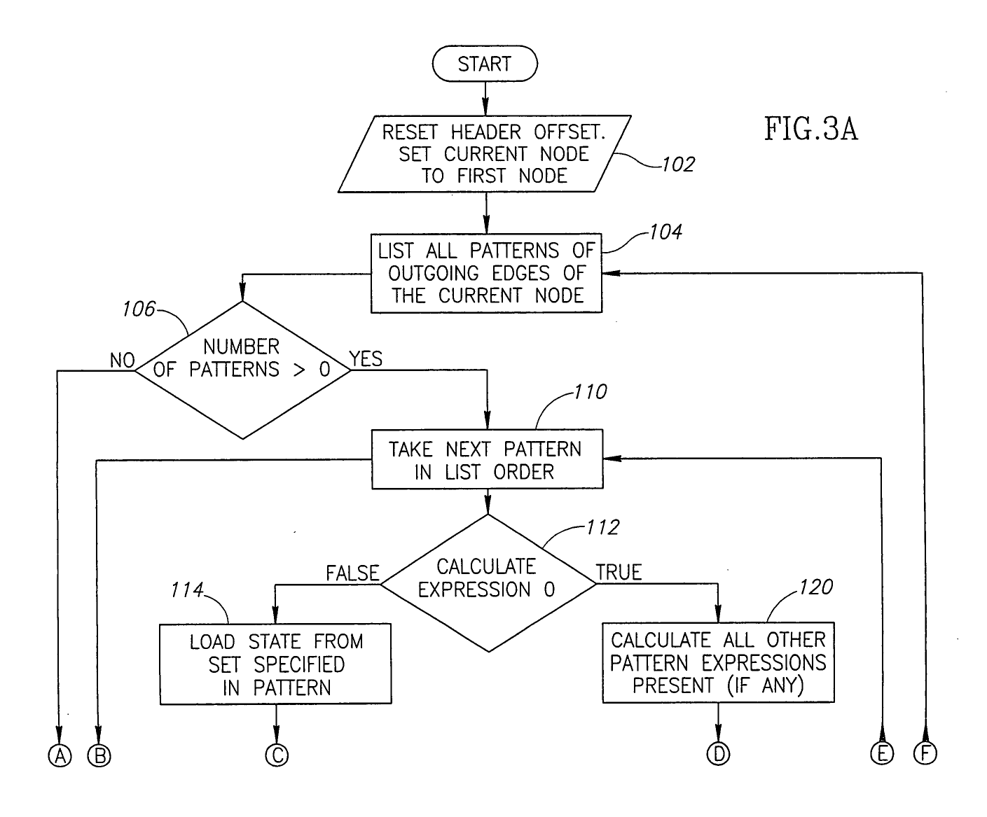

1.1. Comparison cell (ccell). Comparison cells have a generic form expressed as:
ccell(offset, length, mask, operation, value)
where the variables are expressed as:
offset—is the offset in bytes from the current header pointer location (see FIG. 2. below);
length—is the number of bytes starting from the offset compared;
mask—is the bit mask applied to the compared bytes before the actual comparison takes place;
operation—can be one of logical operations including eq (equal), neq (not equal), gt (greater), gte (greater or equals), lt (less), le (less or equal);
value—is the sequence of bytes to which result of the operation is compared—if there is a match, then the cell result is true, otherwise the dell result is false.

When the cell, here, for example, ccell, is calculated, the mask is applied on length bytes starting at offset and the resulting value is taken as a cell result. In all cell matching operations, only the number of bytes equal to the variable length can be used. If necessary, the variables mask and value are padded with zeros on the left. Typically, the above described logic operations are performed on this variables (as shown and described here). However, arithmetic operations on the cell result can be additionally performed.

Optionally, a numerical base of operation (opbase) can be specified. By default, cell values are treated as sequences of bytes. If opbase is specified, the cell value is treated as a number with its numerical base corresponding to the value of opbase, while each byte of the value is treated as a digit in ASCII coding. The first byte of the cell value represents the digit with the highest significance. Here, for example, bases of 2, 8, 10 and 16 can be defined.

If the value of such operation is loaded by a loadable cell (detailed immediately below), it must first be converted to network byte order.

1.2. Loadable cell (lcell or LCELL). Loadable cells have a generic form expressed as:
lcell(offset, length, mask, operation, eventmask, load, [condition, expire])
where, offset, length, mask and operation have been described above for the comparison cell (ccell); and
eventmask specifies which events can be generated by a cell. It can contain any combination of the following flags:
   match—generate an event if cell returned true;
   load—generate an event if cell value was loaded; and
   expire—generate an event if cell value was expired.

All events generated during DCG traversal, must be attached to the output of the process. The precise meaning of the event and of its content is implementation dependent.

An optional expire flag indicates the time period (in milliseconds) after which the loaded cell value must be discarded (expired). If not specified, a default expiration value of 60000 should be used.

The first time a loadable cell is checked, the value obtained from the operation is “loaded”, i.e., added to the list of values bound to a specific edge of a DCG (FIG. 1). The next or subsequent time a loadable cell is checked, it acts as a comparison cell, i.e., its previously loaded value is used in the comparison operation. The result of a loadable cell, when no corresponding value is loaded for it, is always true.

If the load flag is set to false, the cell can only be compared to the previously loaded value, and it can never be loaded. If a value was not loaded for such a cell, then its result is false. This is because the same loadable cell can appear more than once in an expression representing a particular pattern. One appearance of a loadable cell can only function in a comparison operation, while others can function in both the load and comparison operations.

At any stage of the classification process, each packet has a special state identifier associated with it. Loadable cells keep different sets of values per this special state and set.

A loadable cell defines a rule for modifying states corresponding to a packet or a pattern. A loadable cell maintains its value per packet state value. Additional separation between states is possible by using the cell in an expression belonging to a specific set in accordance with the Patterns detailed below. Set numbers take any value in the range [0 . . . 6]-0 indicates an empty set. Loadable cells from such a set always return false, and their results are not added to packet's state. State set 1 is the default, and the main state of a packet belongs to this set. State set 2 is used for calculating a state which acts as a session aggregation identifier (aggregation identifier). State set 3 is used for flow aggregation identifier (aggregation identifier) calculations. State set 4 is used for end-of-flow state calculation. State sets 5 and 6 are reserved for particular implementation purposes.

For example, if two packets p1 and p2 have the cell values 0xff and 0x00(in hexadecimal format) for the loadable cell (lcell1), and they have different states (state 1 and state 2), before checking lcell1, loadable cell (lcell1) will load the value for both p1 and p2, and the cell result will be true for both packets (and not true and false). When a loadable cell is processed (loaded or compared) the cell's value is added to the packet's state (the method in which value result is added to the packet's state, as detailed below).

A loadable cell may have a condition (Boolean expression with comparison or loadable cells with load flag set to false and condition set to null (Ø) attached to it. Only if the condition is true the loadable cell will be processed.

1.2.1 Global Loadable Cell (GLC). A GLC is a loadable cell with a result common to all patterns referencing it.

When a Global Loadable Cell (GLC) is loaded and/or compared, its result is loaded for each pattern in the DCG referencing it. The state used for recording is the state which was valid for each particular referencing pattern during edge traversal. Edges of the DCG referencing the GLC that were not traversed for the packet in question are not modified.

For example, in FIG. 1, if patterns P1, P3 and P4 reference the same GLC, and a packet ended up in node 4, while its states were 0 before P1, and 1 before P3, than loading of GLC value in P3, will result in modifications in P1, but not in P4. If the value loaded in P3 was 0xff, the list of states in P3 will be updated with (2,0xff and in P1 with (1,0xff).

A result of a loadable cell (or cells) can be calculated by the following process.
a. Calculate the cell's conditional expression if any. If expression is false—return false.
b. Calculate the cell's value by using offset, length and mask.
c. Append the value to the packet's state as described below. The value of one loadable cell can be added to the packet's state only once during pattern calculation.
d. Lookup the packet's state in the appropriate set. If not found—return false.
e. Lookup cell's identifier in the found state. If not found—return false.
f. Perform a cell operation on the found value and return a result.
g. Temporarily store the cell result, packet state and cell value. If the same cell appears again in the expression—use the stored values.
h. If the pattern matches, add the packet state (as it was stored) to the appropriate set.
i. If the load flag is true, add the stored result to the appended state, overwriting any previous value, if any.

Predefined cell values can exist as a substitute for offset, length and mask parameters. These values are as follows:
DUMMY—Value that always matches (equals to 0x01, 0x01, with a length of 1 byte if loaded).
DIRECTION—Specifies packet direction. 1—incoming, 2—outgoing. Length of 1 byte.
INCOMING—Equal to 1 if incoming packet. Length of 1 byte.
OUTGOINT—Equal to 1 if outgoing packet. Length of 1 byte.
TIMESTAMP—Time when the packet was received by the engine. Length of 4 bytes.
LENGTH—Total length of the packet. Length of 2 bytes.
CLASSID—Number of last traversed node. Length of 1 byte.
SET1, . . . , SET6—Current state of the packet in particular set. Length of 8 bytes.

Additional values can be predefined by a particular implementation.

1.2.2. Variable Cells. Under some special circumstances it is not possible to know the precise offset and length of a cell. For such cases, variable cell parameters are defined. The amount of processing required for calculating a result of variable cells is significantly higher, so they must be used with care.

Variable cell offset (voffset) is an offset of the first occurrence of specific value with given length (valofft), with optional constant (constofft) added. This is expressed as:
voffset(value, length, constofft)=min [header, valofft]+constofft;

Variable cell length (vlength) is a distance in bytes between cell offset and given variable offset voffset(value, length, constofft). This is expressed as:
vlength(voffset)=min [maxlen, voffset−offset]

Operations on cells. Cells (of all types) can participate in Boolean expressions, with AND, OR, NOT and XOR operations. Boolean constants 1 and 0 can be used as well. Results of these expressions can be either true or false, and should be calculated according to the rules of Boolean algebra. The expression should be calculated from left to right, with AND taking precedence over other operations. When evaluating a loadable cell, the state change in a packet takes place immediately.

2.0. Patterns. Patterns are classification entries that are tied to particular edges in the DCG. A pattern (pattern) has a generic form expressed as:
pattern(header, expr0, expr1, . . . , expr6, set)
where:

header (HEADER in FIG. 2) specifies the length of a packet header classified by the given pattern. It can be either a fixed integer positive (0-65535), or a loadable cell with load flag set to false, condition to NULL and expires to 0, this loadable cell known as an HCELL (FIG. 2). In the latter case the value loaded by the cell is used as a header length, and it is not appended to the packet state. Also, in this case, a headerunit parameter must be supplied, which specifies in which units (multiple of bytes) the header length is measured.

expr0 is a cell expression as specified above in “Operations on cells”. This expression can only contain comparison cells. Only if this expression returns TRUE, all other expressions of a pattern are calculated.

expr1-expr6 are cell expression as specified above in “Operations on cells”. These expressions can contain any types of cells. Each expression is calculated for a particular state set (as described above).

set indicates a specific state set, which needs to be checked if the pattern returns false. If a particular state set contains a state which matches the current packet's state, then the result of the pattern is considered to be “true”. If set number 0 is used, then the result of such a lookup will always be “false”.

Each edge in DCG can have only one pattern attached to it. When a pattern is matched with a packet, the current packet header pointer is advanced by header number of bytes.

3.0. Data Hierarchy

FIG. 2 shows an exemplary data structure. The elements of this data structure are indicated in the respective boxes, in accordance with the hierarchy of the data structure. Arrows indicate correspondence between components of the data structure. DCG organization is for this data structure is shown in FIG. 1. The list of states, defined as variables (STATE1, . . . , STATEn), is potentially large, and is typically organized in a hash table, constructed in accordance with known conventions. This list of states corresponds to a particular pattern, and is typically embedded therein.

If one of the cells from the lists of loadable cells, LCELL1, . . . , LCELLn, (in accordance with the loadable cells defined above) is a GLC, then it can be referenced by multiple patterns, and it must maintain references to all sets from all patterns, from which it was originally referenced. During DCG traversal, the list of references to traversed nodes is maintained. When the GLC is updated, it modifies each set that it references, only if the pattern of this set exists in this list.

Timestamps TIME1, . . . , TIMEn indicate the last modification time for a particular state or value, and used in calculation of expiration times. States and cell values can have separate expiration timers; however, a state can not expire before all of its corresponding values have expired. Timestamps for states are modified when a packet with a particular outgoing state matches the pattern. The timestamp for a loadable cell is modified when a cell is processed (either loaded or compared).

4.0. Expiration

States and loadable cell values must expire according to an expiration timeout for a particular cell. A background process must traverse a whole DCG or one path (from root to leaf node) every 1000 milliseconds. Timestamp values in a loadable cell value data structure and the state data structure must be compared to the timestamp of the start of the expiration process. If expiration occurs, cell value must be released. If state expiration occurs and it has no cell values attached, it is released as well. During expiration traversal, all nodes, from the currently processed node, to every connected leaf node are considered locked, and pattern matching against edges connected to these nodes is not possible.

5.0. DCG Synchronization

Two DCGs with identical configurations can be synchronized in accordance with one of three synchronization methods, Full, Periodic and Single.

In a Full synchronization, all loaded state/cell data is transferred from one DCG to another.

In a Periodic synchronization, only those states and cell values are included that have been changed since the time indicated by the provided timestamp.

In a Single synchronization only data changed as a result of matching of a single packet against a DCG is transferred.

Changes made by an expiration process are not synchronized. Expiration processes must run separately against each DCG. System clocks of the systems running each DCG must be synchronized. Clock synchronization can be performed by any conventional method.

All synchronization changes must be packed in a structure, which has node numbers, cell identifiers and set numbers as unique identifiers.

Turning also to FIG. 3, there is detailed a process, in the form of a flow diagram, in accordance with an embodiment of the present invention. The process of FIG. 3 will be described with respect to the DCG of FIG. 1, with the numbers of the nodes corresponding thereto. This process is typically passive, as it typically does not modify packet data. The process results in incoming packets being classified in accordance with their individual characteristics as well as those of its data flow. The classification process as described herein is such that it modifies the DCG data dynamically and continuously (on-the-fly).

Initially, an incoming packet is received. This packet is then assigned the variables “header offset” and one state variable for each set (SET0, . . . , SET6, as shown in FIG. 2). The received packet, at block 102, has its “header offset” set to a value of zero (0) and each state, defined as variable (state definition), associated with the packet is set to a value of null (▭). Also at this block, the variable for the current node is set to node 1—corresponding to Node 1 of FIG. 1.

At block 104, all patterns associated with outgoing edges of a current node are listed. For example in accordance with the DCG in FIG. 1, the list for node 1, the current node, will be 2 (the outgoing edges being P1 and P2). The list is analyzed at block 106 to see whether or not it is empty. If the list is empty, as there are not any outgoing edges, the process moves to block 108, where the classification ends.

Alternately, if the list is not empty, as there are outgoing edges, the pattern is taken in accordance with its order on the list at block 110. The pattern includes seven expressions, known as expr0, . . . , expr6. The first expression (expr0) is then calculated at block 112. The calculation process of block 112 will now be described by reference to FIG. 4.

As discussed above, each expression includes cells, that are now processed individually, in block 202. In block 204, cell value is calculated using the variables offset, mask and length, as detailed above, associated with each of the cells in the expression. The process moves to block 206, where the cell is analyzed if it is a comparison cell.

If the cell is found to be a comparison cell (in accordance with the definition detailed above), the process moves to block 208. In block 208, the cell result is calculated, by applying the logical operation to cell value calculated at block 204 and value variable of a cell. The cell result, that has been calculated, is either true or false. The cell result is then recorded in temporary storage, at block 240.

Returning to block 206, should the cell not be a comparison cell, the process moves to block 210. Since it was found not to be a comparison cell, the cell is a loadable cell of either GLC or a regular loadable cell. In this block it is determined if an optional cell variable “conditional expression” (described above) is present.

If the conditional expression is present, it is calculated in block 212 in accordance with expression calculation algorithm, which involves a recursion. If the expression is not true, the cell result is set to false at block 214, and the process moves to block 230.

Returning to block 210, if the conditional expression is not present, and returning to block 212, if the conditional expression returned true, the process moves to block 220. In this block, a lookup of a pair of values (packet state and cell value calculated at block 204) is performed in a table associated with current pattern, as shown in FIG. 2.

The process moves to block 222, where it is determined if the cell value is found in the lookup. If the cell value can not be found in the lookup, the cell result is set to “true”, at block 224, and the process moves to block 230. Alternately, if the cell value is found in the lookup, then the cell result is calculated in block 226, by applying the logical operation to the cell value calculated at block 204 and the result of the lookup. The cell result, that has been calculated, is either true or false. The process then moves to block 230.

At block 230, the value of the load flag (defined above) of the cell is analyzed. If the load flag is found not to be true, then the process moves to block 240. Alternately, should the load flag value be true, the process moves to block 232, where a new packet state is calculated.

This new packet state can be calculated in accordance with the following exemplary process. For this example, a state is a 64 bit value. Each packet is assigned a zero state before starting the traversal of the DCG. Each time a loadable cell is processed or loaded for a packet, its value is used to calculate a new state. Loadable cell value is padded with zeros on the left up to 64 bits (if length is smaller). If the result is zero it is changed to 1. The result is arithmetically added to the current state (overflow not handled), and the resulting value is used as a new state. The process moves to block 234. At this block, cell value calculated in block 204, and new packet states are recorded in a temporary data set. The process moves to block 240.

In block 240, as stated above, the cell result is then recorded in temporary storage. The process moves to block 242. If there is a new cell to be taken, the process returns to block 202, where it repeats. If all cells have been analyzed and exhausted, the process moves to block 250. At this block 250, all recorded cell results are extracted from temporary storage and the analyzed expression is calculated from these extracted results according to rules of Boolean algebra (as described above).

expr0 has now been calculated, in accordance with flow diagram of FIG. 4, and if false, the process moves to block 114 (FIG. 3), where packet state is looked up in a state set (as shown on FIG. 2). The number of the set used for this lookup is specified by pattern's variable set as described above. At block 116, if the lookup was successful, i.e. a value for packet state was located, the process moves to block 130. Alternately, if the lookup was unsuccessful, the process returns to block 110.

Returning to block 112, if expr0 has been calculated to be true, the process moves to block 120, where all remaining expressions of the pattern (if any) are calculated according to the process of FIG. 4. Regardless of any other pattern expressions and their results, the process moves to block 130.

In block 130, the header size is calculated in accordance with the rules detailed above. The calculated header size is recorded in temporary storage. The process moves to block 132, where the list of patterns is analyzed to see if there are more patterns. If there are more patterns, the process returns to block 110. If there are not any more patterns, the process moves to block 140.

At block 140, all of the patterns that have been analyzed are checked for matches. Typically, a match occurs when the pattern completely corresponds to the packet. Alternately, the system can be programmed such that a match can occur upon a partial correspondence of the pattern to the packet.

If there are not any matches, the process moves to block 108 where it ends. Alternately, if there are any matches, the process moves to block 142. At this block the current node is updated to be a node connected by the edge with the highest priority matched pattern. This node updating is equivalent to advancing to the node connected by the edge with the highest priority matched pattern. In addition, all state modifications performed during the calculation of the chosen pattern are recorded in DCG, and packet states are updated.

The process then moves to block 144, where the “header offset” is incremented by a calculated header size of the pattern selected in block 142. The process then returns to block 104, where this new node is analyzed, as has been previously detailed above. This process continues for all subsequent nodes until block 108 is reached.

A unique identifier of the ending node, in accordance of the numbering convention described above, is used as a classification identifier. The state from set 2 is taken as Session identifier and the state from set 3 as Flow identifier. All events generated by loadable cells during traversal of the DCG must be appended to the output.

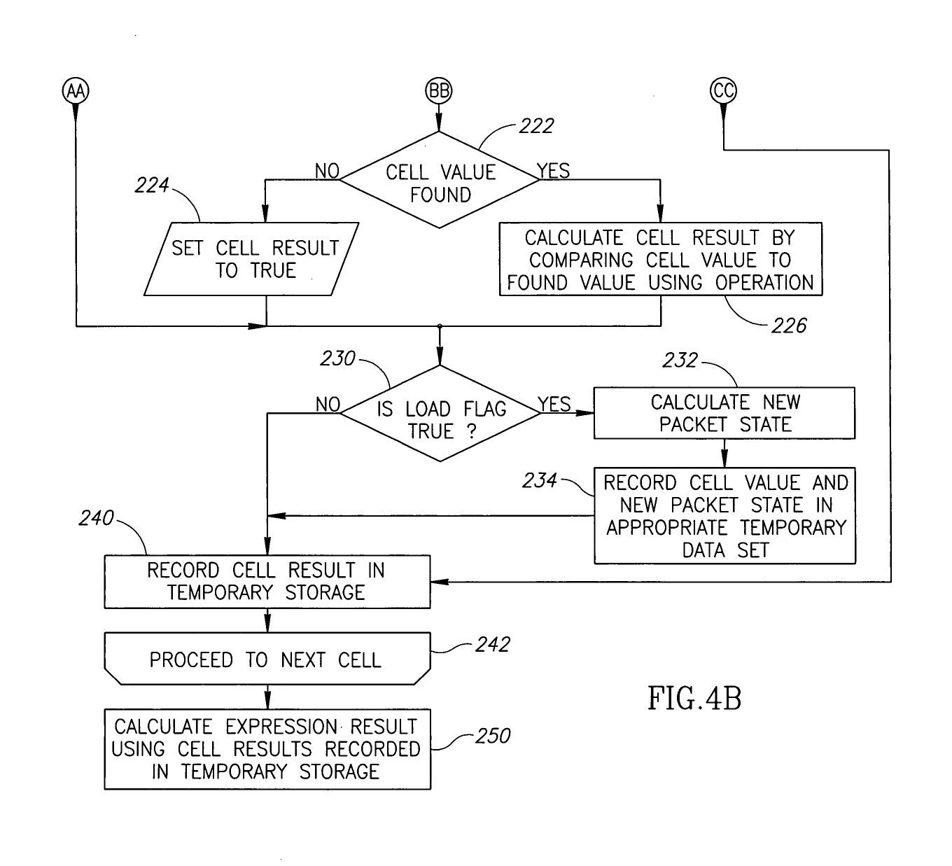

Turning now to FIG. 5, there shown a Classification Engine (CE) 300 on which the processes of embodiments of the invention, for example, as shown in FIGS. 3 and 4, and described above, can be performed. Typical operating systems employing this engine 300 utilize kernel space 302, separate from user space 304.

The engine 300 typically operates within a server, computer-type device or the like, for example, a chip microcontroller, or embedded platform. The server typically includes storage media, processors (including microprocessors), and related hardware and software.

The kernel space 302 includes a network driver 310, coupled with a kernel module 312, and an algorithm module 314. The kernel module 312 and the algorithm module 314 can be implemented as a single module (as shown by the broken line box). The user space 304 includes an Event Module 322, and a Configuration and Control Module 324, both coupled to a Signaling Module 326.

Packets enter the system 300, connected to a network, through the Network Driver 310, and are forwarded to the Kernel Module 312.

The Kernel Module 312 can be implemented as a loadable kernel module or driver. It is designed to support functions including: 1) Upon initiation, switching the Network Driver 310 into promiscuous mode, such that all packets on monitored interface will be accepted by the Network Driver 310; 2) Receiving packets from the Network Driver 310; 3) Deciding, according to configuration, which packets should be forwarded to the algorithm module 314 and which ones should be discarded; 4) Forwarding any necessary packets to the Algorithm Module 314; 5) Implementing a set of commands for communication with Configuration and Control module 324; 6) The ability to configure the DCG in the Algorithm Module 314; and 7) handling packets rejected by the Algorithm Module 314, by forwarding them back to the network (from which they were received) to a fallback engine. For that purpose, it must change the destination Medium Access Control (MAC) address of the packet, to that of the fallback engine (the fallback engine must recognize such packet and let them through, even if it's rejected by internally configured rule).

The Algorithm Module 314 typically includes a complete implementation of a Classification Algorithm. Packets are taken from the incoming queue and processed against the DCG. If packet is rejected, it is placed into the outgoing queue. At the end of DCG processing Flow identifier, Session identifier, Classification identifier, and some additional information is obtained. The module 314 typically maintains a hash table with a Flow identifier as a lookup key, of all results calculated. Only if a change occurred in the table, or the DCG result came with an event attached, the module 314 must forward this result to the Event Module 322.

Any change to the DCG during packet processing can be optionally forwarded to the Event Module 322. In addition, the Algorithm Module 314 must support synchronization polling requests from the Event Module 322. Any such request must contain a timestamp. The Algorithm Module 314 returns all changes in the DCG since the time indicated by the supplied timestamp.

One possible implementation for the Algorithm Module 314 is now described. The module 314 will maintain a pair of queues to the Event Module 322, which uses a communication socket in the user space 304. Every result, for example, classification data, that needs to be forwarded, is sent through this queue, from the module 314 to the Event Module 322. Algorithm Module 314 implementation must associate a counter with each cell and pattern, and, according to the specific configuration, periodically forwards values of these counters to the Event Module 322. DCG configuration is obtained from the Kernel Module 312 through specially formatted packets, or from command messages originating at Configuration and Control Module 324.

The Event Module 322 receives and processes classification data, including packet classification results and related events. This module 322 is responsible for communication with the Algorithm Module 314. Upon initialization, it creates a communication channel to the Kernel Module 312. All events received from the Kernel Module 312 must be processed, and if necessary, forwarded to the system via the Signaling Module 326. Algorithm statistical information should be maintained and accumulated by the Event Module 322 for forwarding to any external monitoring facility or storage media. This Event Module 322 is responsible for the synchronization of the engine 300 as described below.

For example, if this engine 300 is running in a master mode, and slave engines (not shown) are configured, the Event Module 322 performs at least one of the following functions: 1) Periodically polling the Algorithm Module 314 for changes and sending returned changes to slave engines in signaling message produced by the Signaling Module 326; 2) Configuring (through special commands) the Algorithm Module 314 to report every change in DCG via the communication socket, and forward every change to the slave engine in a signaling message produced by the Signaling Module 326.

The Configuration and Control Module 324 maintains and provides configuration information for the system 300 and controls the packet classification process. This module 324 is responsible for maintaining the configuration of the classification engine 300. Configuration parameters may be stored in local files, but interface to external management facilities can be implemented as well. The Configuration and Control Module 324 loads the available configuration parameters on startup, and supplies them to other modules.

Configuration of the Kernel Module 312

The Configuration and Control Module 324 opens a control channel 340 to the Kernel Module 312 (shared with the Algorithm Module 314 if implemented as a single module) on startup. All configuration parameters are supplied through command messages on the control channel 340. All defined parameters are listed below: 1) a list of rules used to determine if a packet should be forwarded to the Algorithm Module 314. Each rule is a Comparison Cell; 2) Address of an external engine (outside of the engine 300—not shown) to which all rejected packets should be forwarded. The address must include Medium Access Control (MAC) address. The decision about which engine to use (for forwarding the rejected packets) is made by the Signaling Module 326, and is based on the list of available engines configured and validated (Hello/Status message was received as described below).

Configuration of the Algorithm Module 314

All configuration parameters are sent in command messages through the control channel 340 (shared with the Kernel Module 312 if implemented as a single module). All defined parameters are listed below:

1) Event mask. Specifies which event types will be transferred to the Event Module 322.

Examples of event mask coding (in binary code) include:
0001—Expiration events.
0010—Load events.
0100—Match events.
1000—Sync events.

2) Reject flag. If set, it signals the Algorithm Module 314 to send all rejected packets to the Event Module 322, otherwise they will be forwarded back to the Kernel Module 312.

DCG Configuration and Encoding

DCG configuration is transferred to the Algorithm Module 314 by encoding the DCG's elements in structures as described below. The same structures can be used in the Algorithm Module 314 to store the DCG itself. Examples of DCG structure coding are provided below.

TABLE 1
Cell definition example

| Field | Length |
|---|---|
| Cell ID | 4 bits |
| Cell Type | 2 bits¹ |
| Cell Structure | Variable |

Notes for Table 1:
Note 1:
Cell Type coding (in binary code) is as follows:
00 - Comparison Cell.
01 - Loadable Cell.
10 - Global Loadable Cell.

TABLE 2
Comparison Cell example

| Field | Length |
|---|---|
| Offset + Length | 2 bytes¹ |
| Operation | 1 byte² |
| Mask | 8 bytes |
| Value | 8 bytes |
| Variable offset value (optional) | 8 bytes |
| Variable length offset (optional) | 2 bytes |
| Notes for Table 2: | |
| Note 1 | |
| “Offset” takes the first 12 bits, “length” the next 3 bits. The 15ₜₕ bit is 1 if one of the predefined values is coded instead of “offset” and “length”. Coding is as follows: | |
| 0x00 - DUMMY. | |
| 0x01 - DIRECTION. | |
| 0x02 - INCOMING. | |
| 0x03 - OUTGOINT. | |
| 0x04 - TIMESTAMP. | |
| 0x05 - LENGTH. | |
| 0x06 - CLASSID. | |
| 0x07-0x0C - SET1, . . ., SET6. | |
| Note 2: | |
| Operation coding takes 6 bits. The 2 next bits indicate variable offset and length. Coding is as follows: | |
| 00000001 - Equal Flag. | |
| 00000010 - Greater Flag. | |
| 00000100 - Less Flag. | |
| 00001000 - Negation Flag. | |
| 00010000 - Decimal base. | |
| 00100000 - Hexadecimal base. | |
| 01000000 - Variable offset. | |
| 10000000 - Variable length. | |
| In the case when variable offset or variable length is present, its 8-byte value is added at the end of the cell structure. When variable length is used, 2 bytes with a 12 bit offset is added as well. | |
| # Variable offset and variable length can not be set in a cell at the same time. | |

TABLE 3
Loadable cell example

| Field | Length |
|---|---|
| Offset + Length | 2 bytes |
| Operation | 1 byte |
| Mask | 8 bytes |
| Event Flags | 1 byte¹ |
| Variable offset value (optional) | 8 bytes |
| Variable length offset (optional) | 2 bytes |
| Notes for Table 3: | |
| Note 1: | |
| Event flags take the first 3 bits, 5 bits are reserved (8 bits total) (in binary code). Coding is as follows: | |
| 001 - Match event. | |
| 010 - Load event. | |
| 100 - Expire event. | |
| For simplification purposes cell expressions are coded using “Reverse Polish” (or prefix) notation schemes (instructions or operators and data operands are treated as objects and processed in a last-in first-out basis). | |
| # Push and Pull operations are defined. Each pattern can have up to 6 state expressions with fixed identifiers 0-5, and each loadable cell (maximum 8) can have an optional condition expression, for which identifiers 6-13 are reserved. | |

First, an operation is coded. If it requires one or two cell definitions, they immediately follow. After that, the next operation is coded and so on, until the last operation of the expression is encountered.

TABLE 4
Cell expression example

| Field | Length |
|---|---|
| Expression ID | 1 byte |
| Operation + Flags | 1 byte² |
| Cell ID + Flags | 1 byte¹ |
| Expiration value (optional) | 20 bit |
| Conditional expression ID (optional) | 4 bit |

Notes for Table 4:
Note 1:
Cell Flags (in binary code), are as follows:
0001 - Load flag set.
0010 - Expiration value present.
0100 - Conditional Expression present.
Note 2:
Operation Coding and Flags (in binary code), are as follows:
00000 - AND.
00001 - OR.
00010 - Result to stack.
00100 - Operand 1 from stack (cell otherwise).
01000 - Operand 2 from stack (cell otherwise).
10000 - Last operation.

DCG is Defined by a List of Patterns.

TABLE 5
Pattern example

| Field | Length |
|---|---|
| Pattern ID | 1 byte |
| Pattern Weight | 1 byte |
| Source Node | 1 byte |
| Destination Node | 1 byte |
| Header | 1 byte¹ |
| Set expressions | 6 bytes |
| Set | 1 byte |

Notes for Table 5:
Note 1:
Header encoding.
Headers can take one of two forms, 1UUUXXXX - where UUU is header unit (0-7) and XXXX is a header cell ID; or 0LLLLLLL - where LLLLLLL is header length (0-127).

Configuration of the Event Module 322

In cases where synchronization is based on polling, the Event Module 322 must know the polling interval (in milliseconds).

Configuration of the Signaling Module 326

The Signaling Module 326 should receive the following configuration parameters: 1) IP address of the System; 2) Initial list of other engines, their addresses and priorities. The Signaling Module 326 implements signaling protocol for communication with other components of the engine 300 or other engines. Functional descriptions of the Signaling Module 326, along with examples of message formats, are now described.

Communication Between Classification Engine 300 and the External System(s)

Messages sent from the engine 300 to external system(s) (not shown) carry information about classification results, determined flow identifiers and Session identifiers. Some classification-related events can be transferred as well. The following message types are defined.

TABLE 6
Classification Engine - External System

| Direction | Message Description |
|---|---|
| Engine to System | Flow open |
| Engine to System | Flow close |
| Engine to System | Remap |
| Engine to System | Session ID change |
| Engine to System | Misc. Event |
| System to Engine | Flow Identify |
| System to Engine | Flow Update |

Flow Open Message

This message indicates creation of a new flow. It is sent when the Signaling Module 326 discovers that the flow identifier received from the Event Module 322 was not present in its internal table.

TABLE 7
Flow Open example

| Field | Size (bytes) | Type/Value |
|---|---|---|
| Flow ID | 8 bytes | Unsigned 64 bit |
| Session ID | 8 bytes | Unsigned 64 bit |
| Classification ID | 1 byte | Unsigned 8 bit |
| N Flow ID cells | Variant | Described in Table 8 |
| | | immediately below |

TABLE 8
Flow identifier Cell example

| Field | Length |
|---|---|
| Cell Length (i) | Unsigned 4 bit (max 8, 0 = last cell) |
| Cell Offset | Unsigned 12 bit |
| Cell Mask | i bytes |

Flow Close Message

This message indicates that existing flow has been closed.

TABLE 9
Flow Close example

| Field | Size (bytes) | Type/Value |
|---|---|---|
| Flow ID | 8 bytes | Unsigned 64 bit |

Remap Message

This message indicates that Classification Identifier of the existing flow has been updated by the engine 300.

TABLE 10
Remap example

| Field | Size (bytes) | Type/Value |
|---|---|---|
| Flow ID | 8 bytes | Unsigned 64 bit |
| Session ID | 8 bytes | Unsigned 64 bit |
| New Classification ID | 1 byte | Unsigned 8 bit |
| Old Classification ID | 1 byte | Unsigned 8 bit |

Session ID Change Message

This message indicates the decision taken by the Classification engine 300 to associate the existing flow with a different session.

TABLE 11
Session identifier Change example

| Field | Size (bytes) | Type/Value |
|---|---|---|
| Flow ID | 8 bytes | Unsigned 64 bit |
| New Session ID | 8 bytes | Unsigned 64 bit |
| Old Session ID | 8 bytes | Unsigned 64 bit |

Miscellaneous Event Message

Any event generated by the Algorithm Module 314 and received by the Event Module 322, is typically forwarded in a Miscellaneous Event message.

TABLE 12
Miscellaneous Event example

| Field | Size (bytes) | Type/Value |
|---|---|---|
| Flow ID | 8 bytes | Unsigned 64 bit |
| Session ID | 8 bytes | Unsigned 64 bit |
| Classification ID | 1 byte | Unsigned 8 bit |
| Event type | 1 byte | 0 - match, |
| | | 1 - load, 2 - expire |
| Cell Classification ID | 1 byte | Unsigned 8 bit |
| Cell ID | 1 byte | Unsigned 8 bit |

Note:
in cases where an ‘expire’ event is sent, the Classification identifier must be equal to a Cell Classification identifier, the Flow identifier must contain the expired state (0, if none), and the Session identifier must contain the expired cell value (0, if none).

Flow Identify Request Message

This request is issued by the system when it wishes to identify a packet (in the case when it does not match any existing flow).

TABLE 13
Flow Identify example

| Field | Size (bytes) | Type/Value |
|---|---|---|
| Packet Data | Variant | Variant |

In response to this message, the engine 300 must issue a “Flow Open” message.

Flow Update Request Message

This request is issued by the system when it wishes to receive updated information for existing flows.

TABLE 14
Flow Update example

| Field | Size (bytes) | Type/Value |
|---|---|---|
| Flow ID | 8 bytes | Unsigned 64 bit |

In response to this message, the engine 300 must issue a “Flow Open” message, if such a flow exists, or a “Flow Close” message, if the flow does not exist.

Communication Between the Classification Engines 300 and Other External Engines

The classification engine 300 described here is suitable for communication with other identically configurable external engines (not shown). Messages sent from the engine 300 to another external engine, or vise versa, carry synchronization information needed for High Availability and Load Balancing.

TABLE 15
Classification Engine - Classification Engine

| Direction | Message Description |
|---|---|
| Engine to Engine | Hello |
| Engine to Engine | Bye |
| Engine to Engine | Ping |
| Engine to Engine | Status |
| Engine to Engine | Sync |
| Engine to Engine | Reject |

Hello Message

This message introduces the engine 300 to another engine. It is sent from the engine with a higher priority to an engine with a lower priority. If DCG fingerprint received does not match the engine's own DCG fingerprint, this message is ignored.

TABLE 16
Hello example

| Field | Size (bytes) | Type/Value |
|---|---|---|
| Priority | 1 byte | Unsigned 8 bit |
| IP Address | 4 bytes | IP Address |
| DCG fingerprint | 8 bytes | See Immediately Below |

The DCG Fingerprint is a 64-bit value which represents DCG configuration. This value is calculated by traversing the DCG and XORing all cell offsets and masks.

Bye Message

This message is sent by a classification engine to all other known engines, when it becomes unavailable.

TABLE 17
Bye example

| Field | Size (bytes) | Type/Value |
|---|---|---|
| Address | 4 bytes | IP Address |

Ping Message

A Ping message is used by an engine to check availability of another engine. Upon reception of such message, the engine must issue a Status response and update its engine table if necessary.

TABLE 18
Ping example

| Field | Size (bytes) | Type/Value |
|---|---|---|
| Priority | 1 byte | Unsigned 8 bit |

Status Message

Status messages indicate that an engine, that issued the message, is online and can be used for synchronization. ‘Number of states’ parameter indicates the total amount of loaded states inside a DCG in the Algorithm Module 314.

TABLE 19
Status example

| Field | Size (bytes) | Type/Value |
|---|---|---|
| Number of states | 4 bytes | Unsigned 32 bit |

Synchronization Message

Synchronization messages contain packet data structures with updated state and cell value information. This allows two engines to have a completely identical structure; accordingly, for any subsequently received packet, an identical classification result will be produced.

TABLE 20
Sync example

| Field | Size (bytes) | Type/Value |
|---|---|---|
| N Sync entities | Variable | Table 21: |
| (length 16) | | Synchronization entity |

TABLE 21
Synchronization entity example

| Field | Length |
|---|---|
| Node ID (0xff - end of list) | 1 byte |
| Cell ID (0xff - state only) | 1 byte |
| Value (state/cell) | 8 bytes |
| Timestamp | 6 bytes |

When sending a cell value, the first synchronization entity must contain the corresponding state with Cell ID of 0xff, and next one(s) of the appropriate cell value.

Reject Message

A Reject message is generated when the Algorithm Module 314 can not process the packet due to the lack of state space in the DCG. The message should be sent to any available engine, and contain as much packet data as possible. This message should be generated only when the Kernel Module 312 can not forward the packet to another engine (for example its Medium Access Control address is not in an Address Resolution Protocol table).

TABLE 22
Reject example

| Field | Size (bytes) | Type/Value |
|---|---|---|
| Packet Data | Variable | Variable |

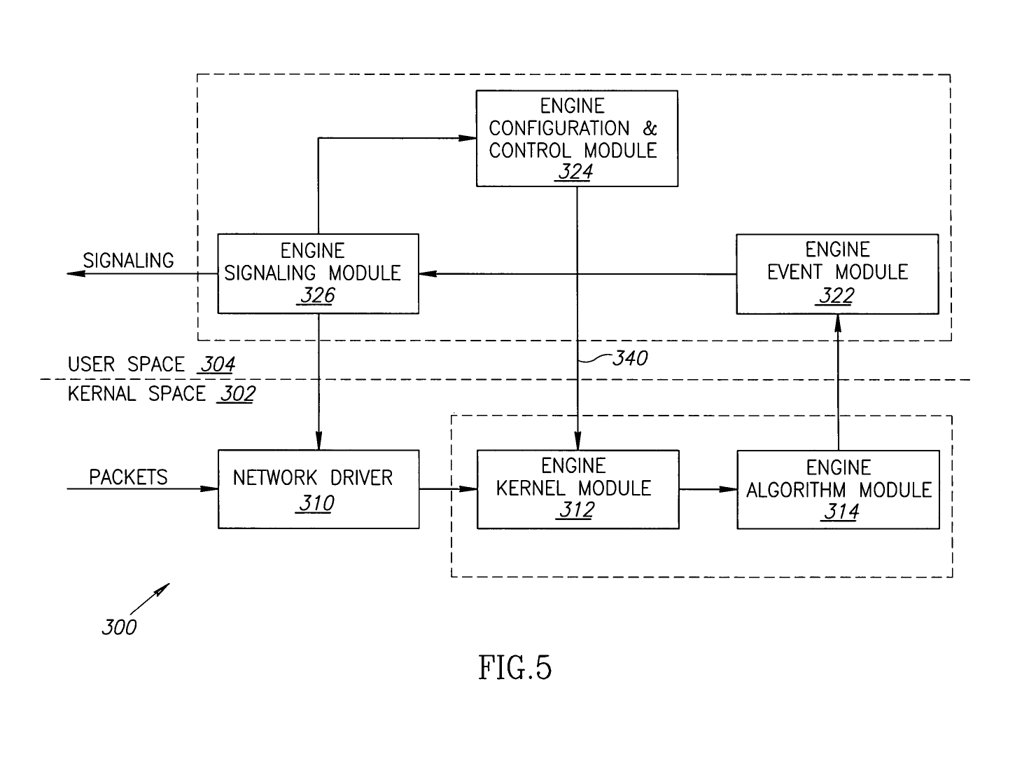

Referring now to FIG. 6, there is shown an example system 400 of the engine 300 (shown in FIG. 5 and described above) in use with a switch 402, and an outside system 404. This outside system 404 is, for example, a Quality of Service (QoS) engine or server. One exemplary QoS engine is Mobile Traffic Shaper™ available from Cellglide Ltd., of the United Kingdom (UK). This system 400 can include one or more additional engines 410a-410n, these additional engine(s) configured identically to the engine 300.

The system 400 operates for traffic flow and packet interception. The engines 300, 410a-410n must be defined as a monitor in packet switch 402 (i.e., it will receive a copy of each packet going into the system). Upon initialization, the network driver of each engine 300 will be switched into promiscuous mode, so that all packets destined to the outside system 404 will be intercepted. When the system 400 includes one or more engines (engines 300 plus an additional engine from engines 410a-410n), they all must be defined as monitors, and a selection function must be configured in each one of the engines, for load balancing purposes, as detailed below.

Load balancing is typically required to handle heavy packet traffic coming into an engine, such as the system 300. Kernel Module 312 of each engine 300, 410a-410n (engines 410a-410n have a Kernel Module identical to Kernel Module 312) will receive a copy of each packet destined for the outside system 404. A special rule in the Kernel Module 312 makes a decision if the packet should be forwarded to the Algorithm Module 314 or dropped. Rules are designed so that their definitions for different engines do not overlap, and that packets with same Flow identifier will be treated by one engine. The rule is defined as a set of comparison cells (as described above). Variable offsets and lengths are not permitted in the definitions of those cells. The rule is considered to match if all comparison cells return TRUE.

The Algorithm Module 314 may reject processing of a packet if its internal state space is exhausted. In that case, this packet must be forwarded from engine 300 to another engine 410a-410n, either through Kernel Module 312, if its MAC address is known, or through the Signaling Module 326. Rules in the Kernel Module 312 are such that the packet with the MAC address of the system itself is forwarded to the Algorithm Module 314 (unless the destination internet protocol (IP) address of the packet matches one on the internally defined operating system (OS) interfaces). In this case, the rules in the Kernel Module 312 are built on the assumption that this packet was rejected by at least one other engine. Any rejected packet received through Signaling Module 326, must be forwarded by the Signaling Module 326 to the Kernel Module 312 by any known message means.

As an option, the aforementioned system 400 can be designed for high availability. High availability involves a scheme defined in the engine 300, ensuring that two, or more engines (engines 410a-410n) have identical DCG states, and can pick-up and resume each other's operation at any given moment, with a smooth transition without data loss in case of failure.

A high availability set of engines can be defined to include any of the engines 300, 410a-410n shown and described here. In any high availability set, one engine operates in a master or active mode, while all other engines operate in a slave mode (receiving synchronization messages). When the engine is in a slave mode, the Kernel Module 312 does not forward any packets to the Algorithm Module 314 (even the packets rejected by other engines). Each engine in a high availability set is given a unique priority value. If an engine received a Hello message from another engine with a higher priority, it switches to a slave mode. If an engine is in the slave mode, and it did not receive a Ping message in 10 seconds, it must switch to a master mode.

Each engine in a high availability set must send a Hello message (as defined for the Signaling Module 326 above) to all known engines with lower priority, and send a Ping (as defined for the Signaling Module 326 above) message to those engines every 5 seconds.

A master engine in a high availability set must constantly send Synchronization (Sync) messages (as defined for the Signaling Module 326 above) to the slave engines. It is up to the master engine itself to decide if it wants to send each change in a separate signaling message or poll the Algorithm Module 314 periodically for accumulated messages. The decision must be enforced by an appropriate configuration of the Event Module 322.

### EXAMPLES

Examples in accordance with embodiments detailed above are now described.

### Example 1

This example is directed to a DCG configuration. This example assumes that each packet arrives with a full Ethernet header at the beginning. Internet Protocol (IP)-level fragmentation is handled, so that each fragment receives the same classification identifier as the first fragment. However, this mechanism can potentially fail if fragments arrive out of order.

This example references various aspects of protocols. The aspects of these protocols are described, for example, in “Internet Protocol DARPA Internet Program Protocol Specification, Request For Comments (RFC) 791, September 1981” (RFC 791), “Transmission Control Protocol DARPA Internet Program Protocol Specification, Request For Comments (RFC) 793”, September 1981 (RFC 793), R. Fielding, et al., “Network Working Group, Request For Comments (RFC): 2616, Hypertext Transfer Protocol —HTTP/1.1”, ©The Internet Society, June 1999 (RFC 2616) and H. Schulzrinne, et al, Network Working Group, Request For Comments (RFC): 1889, RTP: A Transport Protocol for Real-Time Applications”, January 1996 (RFC 1889), all four of these documents are incorporated by reference herein.

In this example, each loadable cell has the following form in the expression: LCELL(load, condition, eventmask). LCELL means LCELL(TRUE, NULL, 0), where condition and eventmask are parameters that have been explained above.

The Loadable header cell (HCELL) has the following form:
HCELL(headerunit)—where headerunit is a value explained above.

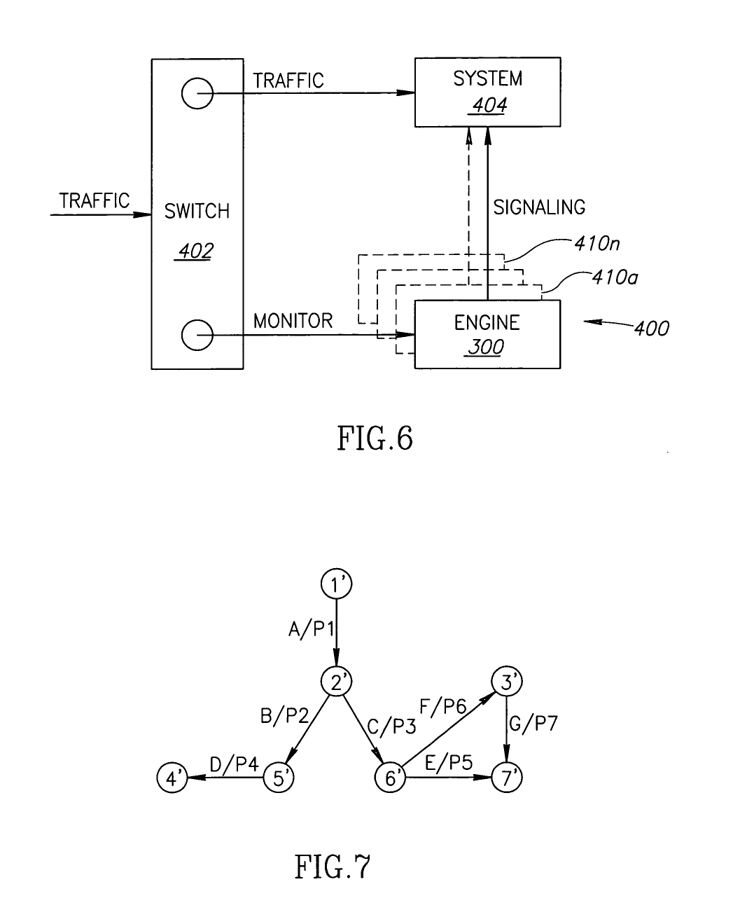

Attention is now directed to FIG. 7, that illustrates a DCG in accordance with this Example. This DCG is similar to the DCG of FIG. 1, as described above, except where indicated. The DCG includes seven nodes 1′-7′ joined by connecting edges A-G, with corresponding patterns P1-P7. The patterns are as follows:

a. Pattern P1.

CCELL11(0x0c, 2, 0xffff, EQ, 0x0800)—IP protocol in Ethernet II header.
PATTERN1(0x0e, CCELL1, NULL, . . . , NULL, 0)—Ethernet header is 14 bytes long.
   b. Pattern P2.
CCELL21(0x09, 1, 0x0f, EQ, 0x06)—TCP protocol.
LCELL22(0x0c, 4, 0xffffffff, EQ)—Source address for session ID.
LCELL23(0x10, 4, 0xffffffff, EQ)—Destination address for session ID.
CCELL24(0x06, 1, 0x20, EQ, 0x20)—More fragments flag.
LCELL25(0x04, 2, 0xffff, EQ)—Message ID.
LCELL26(0x0c, 4, 0xffffffff, EQ)—Source address.
LCELL27(0x0c, 4, 0xffffffff, EQ)—Source address for flow ID.
LCELL28(0x10, 4, 0xffffffff, EQ)—Destination address for flow ID.
EXPR21(CCELL24∥LCELL25(FALSE, NULL)&LCELL26(FALSE, NULL))—Conditional expression for LCELL25 and LCELL26.
PATTERN2(0x14, CCELL21,
LCELL25(TRUE,EXPR21)&LCELL26(TRUE,EXPR21),
LCELL22&LCELL23, LCELL27&LCELL28, NULL, NULL, NULL, 0)

Here, CCELL21 checks if the packet is in TCP. If not, the pattern fails and classification ends. LCELL22 and LCELL23 load source and destination addresses into Set 2, which acts as a part of the flow identifier. LCELL25 and LCELL26 optionally load and add a message identifier and a source address into the packet's state Set 1. These cells, LCELL25 and LCELL26 load only if fragmentation is present. These cells load only if the ‘more fragments’ flag is set (CCELL24), or if they both were loaded previously with the same state.

c. Pattern P3.

CCELL31(0x09, 1, 0x0f, EQ, 0x09)—UDP protocol.
LCELL32(0x0c, 4, 0xffffffff, EQ)—Source address for flow ID.
LCELL33(0x10, 4, 0xffffffff, EQ)—Destination address for flow ID.
CCELL34(0x06, 1, 0x20, EQ, 0x20)—More fragments flag.
LCELL35(0x04, 2, 0xffff, EQ)—Message ID.
LCELL36(0x0c, 4, 0xffffffff, EQ)—Source address.
LCELL37(0x0c, 4, 0xffffffff, EQ)—Source address for flow ID.
LCELL38(0x10, 4, 0xffffffff, EQ)—Destination address for flow ID.
EXPR21(CCELL34∥LCELL35(FALSE, NULL)&LCELL36(FALSE, NULL))—Conditional expression for LCELL35 and LCELL36.
PATTERN3(0x14, CCELL31,
LCELL35(TRUE,EXPR31)&LCELL36(TRUE,EXPR31),
LCELL32&LCELL33, LCELL37&LCELL38, NULL, NULL, NULL, 0)
   This pattern is identical to pattern P2, except for the protocol recognition (CCELL31).
   d. Pattern P4.
HCELL41(0x0c, 1, 0x0f)—TCP header length in 32 bit units.
CCELL42(0x00, 2, 0xffff, EQ, 0x0050)—Source TCP port 80 (HTTP).
CCELL43(0x02, 2, 0xffff, EQ, 0x0050)— Destination TCP port 80 (HTTP).
LCELL44(0x00, 2, 0xfffff, EQ)—Source port.
LCELL45(0x02, 2, 0xfffff, EQ)—Destination port.
CCELL46(DIRECTION, EQ, 0x01)—Incoming packet.
LCELL47(SET3, EQ)—Flow ID for EOF calculation.
CCELL48(0x0E, 1, 0x01, EQ, 0x01)—FIN.
LCELL49(INCOMING, EQ)—Loads when incoming FIN packet.
LCELL4A(OUTGOING, EQ)—Loads when outgoing FIN packet.
LCELL4B(DUMMY)—Always matches.
PATTERN4(HCELL41(4), CCELL42∥CCELL43, NULL, LCELL44(TRUE,
CCELL46)&LCELL45(TRUE, !CCELL46), LCELL44&LCELL45, LCELL47&LCELL49(TRUE, CCELL46&CCELL48)&LCELL4A(TRUE,
!CCELL46&CCELL48)&LCELL4B(TRUE, LCELL49&LCELL4A, LOAD), NULL, NULL, 1)

Here, the pattern matches if either the source or the destination port is 80, in accordance with RFC 2616. The pattern loads the source port for the incoming packet and the destination port for the outgoing packet in order to create a triplet session identifier.

State Set 4 contains an expression which identifies the end of a particular TCP flow and generates an event when this happens. First, the flow identifier from Set 3 is loaded into packet state. Loadable cells 49 and 4A load the appropriate direction value only if FIN in that direction was observed. Loadable cell 4B is used for event generation purposes only. It triggers an event when both 49 and 4A are loaded for a particular flow identifier.

This pattern can also match if the fragment without any TCP header is received. In this case, the packet will have ‘more fragments+message id’ state in set 1, loaded by pattern P2, and recorded in pattern P4, as the previously matched outgoing state.

e. Pattern P5.

CCELL51(0x00, 2, 0xffff, EQ, 0x1388)—Source UDP port 5000 (RTP).
CCELL52(0x02, 2, 0xffff, EQ, 0x1388)—Destination UDP port 5000 (RTP).
LCELL53(0x00, 2, 0xfffff, EQ)—Source port.
LCELL54 (0x02, 2, 0xfffff, EQ)—Destination port.
CCELL55(DIRECTION, EQ, 0x01)—Incoming packet.
LCELL56(SET3, EQ)—Flow ID for EOF calculation.
CCELL57(0x0E, 1, 0x01, EQ, 0x01)—FIN.
LCELL58(DIRECTION, EQ)—Loads when incoming FIN packet.
LCELL59(DIRECTION, EQ)—Loads when outgoing FIN packet.
LCELL5A(DUMMY)—Always matches.
PATTERN4(8, CCELL51∥CCELL52, NULL, LCELL53(TRUE,
CCELL55)&LCELL54(TRUE, !CCELL55), LCELL53&LCELL54,
LCELL56&LCELL58(TRUE, CCELL55&CCELL57)&LCELL59(TRUE,
!CCELL55&CCELL57)&LCELL5A(TRUE, LCELL58&LCELL59, LOAD), NULL, NULL, 1)
   This pattern is identical to pattern P4 except for the port recognition (CCELL51 and CCELL52).
   f. Pattern P6.
PATTERN6(8, NULL, . . . , NULL, 1)
   This pattern simply skips the User Datagram Protocol (UDP) header.
   g. Pattern P7.
CCELL71 (0x00, 1, 0x03, EQ, 0x01)—RTP version.
CCELL72(0, 1, 0x7f, EQ, 0x60)—RTP Payload Type (video MPEG-2).
PATTERN7(0x0C, CCELL71 &CCELL72, NULL, . . . , NULL, 1)
   Header length here is irrelevant, as RTP is a leaf node.

### Example 2

This example is directed to an implementation of the process detailed in FIGS. 3 and 4. This example details memory requirements and execution time of the aforementioned process. For this particular implementation, to ensure high performance of the algorithm and to maintain a minimal memory footprint, the following rules were applied. These rules were as follows:
a) Default expiration timeout for any state or cell value is 60000 milliseconds.
b) Maximum expiration timeout is 600000 milliseconds.
c) DCG can be at most eight levels deep and contain up to 256 nodes.
d) Each node can have at most 16 outgoing edges.
e) Each pattern is limited to 16 cells with up to 8 loadable cells.
f) The maximum number of different states in all sets in one pattern is 65536.
g) Cell length is limited to 64 bits and it can be expressed in whole bytes only.
h) State is a 64 bits value.
i) The structure [LCELL,VALUE,FLAG,TIME] is 16 bytes long, and [STATE,TIME] is 14 bytes long, in accordance with the structures shown in FIG. 2 and described above.
j) GLC can be referenced from, at most, 8 patterns.

In accordance with these rules, the maximum memory requirement for the process can be calculated. For each pattern (edge) up to 65536*14=896 KB can be spent on storing states, and up to 65536*8*16=8 MB can be spent on storing the cell values. This results in up to ˜9 MB for each pattern or 256*9=2.25 GB for the DCG of the maximum possible size. This is an upper bound for all process memory consumption.

If packet processing causes creation of a new state, and the maximum amount of states for this pattern is reached (65536), classification of such packet should be refused, and it should be forwarded from the present engine, where it is being applied, to an alternative engine for classification, in accordance with the procedure described above.

In general, if the DCG has N patterns and M packets are processed against this DCG, and there is no hash table for state lookup, execution time of the process will be bound by the complexity expression: O(M\hat{ }2*log(N)), where,
O is a complexity function (Landau symbol);
M is a variable representing the number of packets classified by using the DCG of the invention;
\hat{ } is an operator for raising M to a power; and
N is a variable that represents the number of patterns inside a DCG used for classification.

Since the DCG is up to 8 levels deep, up to 8 patterns can be checked for each of the M classified packets. This can create up to 128 cell operations, with up to 64 of them resulting in an additional lookup in the state table. For purposes of this Example, a hash table of size 256 was implemented. Accordingly, the maximum size of the array searched during state lookup was of 64*256=16384 elements. Each comparison cell operation or array search was a comparison of 64 bit values located in memory at known offsets. These operations were performed on the ULTRA SPARC CPU (64-bit) (commercially available from Sun Microsystems of California). Each operation took no more than 10 CPU cycles.

If 20000 operations are to be executed, and each one takes 100 CPU cycles, with the CPU running at 400 MHz (not taking Scalable Multi Processing (SMP) into account), processing of up to 200 packets per second is expected, at minimum. This equals approximately to 3 MB/sec with Maximum Transfer Unit (MTU) of 1500 bytes. For a smaller DCG, this number will be significantly higher.

The above described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

1. A packet classifier comprising:
a. a data structure for storing classification information, the structure contained in a memory and comprising a graph including a plurality of nodes connected by at least one edge for corresponding to at least one pattern, the graph configured such that movement between the nodes occurs upon at least one packet matching the at least one pattern; and
b. a processor, including program means, for applying at least one packet to the data structure to classify the at least one packet.

2. The packet classifier of claim 1, wherein the graph is configured accommodate dynamically changing data.

3. The packet classifier of claim 1, wherein matching includes at least a partial correspondence between the at least one packet and the at least one pattern.

4. The packet classifier of claim 1, wherein each node includes at least one of an incoming edge or an outgoing edge.

5. The packet classifier of claim 1, wherein the graph is configured to accommodate state based inspection data.

6. The packet classifier of claim 1, wherein the graph is configured to accommodate packet aggregation data.

7. A method for searching a memory to locate information in a packet classification system, comprising the steps of:
a. structuring the information so that it includes at least one graph including a plurality of nodes connected by at least one edge for corresponding to at least one pattern, the at least one graph configured such that movement between the nodes occurs upon at least one packet matching the at least one pattern; and
b. electronically searching the information in the memory to classify the at least one packet.

8. The method of claim 7, wherein the at least one graph is configured accommodate dynamically changing data.

9. The method of claim 7, wherein the matching of the at least one packet to the at least one pattern includes at least a partial correspondence between the at least one packet and the at least one pattern.

10. The method of claim 7, wherein each node includes at least one of an incoming edge or an outgoing edge.

11. The method of claim 7, wherein the electronically searching the information in the memory to classify the at least one packet includes analyzing the at least one packet for a determination of its state.

12. The method of claim 7, wherein the electronically searching the information in the memory to classify the at least one packet includes analyzing the at least one packet for a determination of at least one aggregation identifier from it.

13. A computer memory storage device, configured to store packet classification data organized in graphs, each graph including a plurality of nodes connected by at least one edge for corresponding to at least one pattern, each graph configured such that movement between the nodes occurs upon at least one packet matching the at least one pattern.

14. The computer memory storage device of claim 13, wherein the each of the graphs is configured accommodate dynamically changing data.

15. The computer memory storage device of claim 13, wherein the matching of the at least one packet to the at least one pattern includes at least a partial correspondence between the at least one packet and the at least one pattern.

16. The computer memory storage device of claim of claim 13, wherein each node includes at least one of an incoming edge or an outgoing edge.

17. A method for classifying packets comprising:
a. providing a graph including a plurality of nodes, connected by at least one edge, and at least one pattern corresponding to at least one edge, the at least one pattern including at least one state definition;
b. applying at least one packet to the graph; and
c. determining at least one state of the at least one packet, including analyzing at least one previously computed state coupled with the at least one state definition.

18. The method of claim 17, additionally comprising:
classifying the at least one packet based on the determined state for the at least one packet.

19. The method of claim 17, wherein the at least one state definition includes a plurality of state definitions.

20. The method of claim 17, wherein the at least one state definition is embedded inside the at least one pattern.

21. The method of claim 19, wherein the plurality of state definitions are embedded in the at least one pattern.

22. The method of claim 17, additionally comprising: storing data corresponding to the at least one determined state, such that the graph accommodates dynamically changing data.

23. A packet classifier comprising:
a. a data structure for storing classification information, the structure contained in a memory and comprising a graph including a plurality of nodes, connected by at least one edge, and at least one pattern corresponding to at least one edge, the at least one pattern including at least one state definition; and
b. a processor, including program means, for applying at least one packet to the data structure and determining at least one state of the at least one packet by analyzing at least one previously computed state coupled with the at least one state definition.

24. The packet classifier of claim 23, wherein the processor additionally classifies the at least one packet based on the determined state for the at least one packet.

25. The packet classifier of claim 23, wherein the at least one state definition includes a plurality of state definitions.

26. The packet classifier of claim 23, wherein the at least one state definition is embedded inside the at least one pattern.

27. The packet classifier of claim 25, wherein the plurality of state definitions are embedded in the at least one pattern.

28. The packet classifier of claim 23, additionally comprising: memory for storing data corresponding to the at least one determined state, such that the graph accommodates dynamically changing data.

29. A computer memory storage device, configured to store packet classification data organized in graphs, each graph including a plurality of nodes, connected by at least one edge, and at least one pattern corresponding to at least one edge, the at least one pattern including at least one state definition.

30. The computer memory storage device of claim 29, wherein the at least one state definition includes a plurality of state definitions.

31. The computer memory storage device of claim 29, wherein the at least one state definition is embedded inside the at least one pattern.

32. The computer memory storage device of claim 30, wherein the plurality of state definitions are embedded the at least one pattern.

33. The computer memory storage device of claim 29, additionally configured to store data corresponding to the at least one determined state, such that the graph accommodates dynamically changing data.

34. A method of searching a memory to locate information in a system for classifying at least one packet comprising:
a. structuring the information in a memory such that it includes at least one pattern, including state-based inspection data and aggregation data for at least one packet; and
b. electronically searching the information in a memory to compare at least one packet to the at least one pattern.

35. The method of claim 34, wherein the at least one pattern is included in a Direct Cyclic Graph.

36. The method of claim 35, additionally comprising: storing the Direct Cyclic Graph in the memory.

37. The method of claim 36, wherein storing the Direct Cyclic Graph in the memory includes establishing a one-to-one correspondence between portions of the Direct Cyclic Graph and the information structured in the memory.

38. The method of claim 37, wherein the portions of the Direct Cyclic Graph include nodes and edges.

39. The method of claim 38, additionally comprising: attaching the at least one pattern to at least one of: at least one node, or at least one edge.

40. The method of claim 39, wherein the at least one pattern includes one pattern, the at least one node includes two nodes, and the at least one edge includes one edge.

41. The method of claim 39, additionally comprising: traversing the Direct Cyclic Graph by moving through the at least one pattern, based on the attachment of the at least one pattern to the at least one node or at the at least one edge.

42. The method of claim 34, wherein the state-based inspection data includes at least one packet state identifier.

43. The method of claim 34, wherein the aggregation data includes at least one of: flow identifier, session identifier or a packet identifier, for the at least one packet.

44. A packet classifier comprising:
a. a data structure for storing classification information, the structure contained in a memory and comprising at least one pattern, including state-based inspection data and aggregation data for at least one packet, and;
b. a processor including program means for searching the data structure to compare at least one packet to the at least one pattern.

45. The packet classifier of claim 44, wherein the at least one pattern is included in a Direct Cyclic Graph, the Direct Cyclic Graph contained in the memory.

46. The packet classifier of claim 45, wherein the Direct Cyclic Graph includes a one-to-one correspondence between portions of the Direct Cyclic Graph and the information in the memory.

47. The packet classifier of claim 46, wherein the Direct Cyclic Graph includes nodes and edges.

48. The packet classifier of claim 44, wherein the state-based inspection data includes at least one packet state identifier.

49. The packet classifier of claim 44, wherein the aggregation data includes at least one of: flow identifier, session identifier or a packet identifier, for the at least one packet.

50. A packet classification system comprising:
a network driver for receiving packets;
a classification module in communication with the network driver for classifying packets received from the network driver;
an event module in communication with the classification module, the event module for receiving and processing classification data;
a signaling module for determining at least one available engine for receiving classified packets, in communication with the event module; and
a control module in communication with the signaling module and the classification module for maintaining and providing configuration information and controlling packet classification.

51. The packet classification system of claim 50, wherein the classification module includes an algorithm module for processing received packets against a direct cyclic graph and a kernel module for controlling packet flow from the network driver to the algorithm module.

52. The packet classification system of claim 51, wherein the event module is configured for creating a communication to the kernel module for controlling packet flow therethrough.

53. The packet classification system of claim 52, wherein the algorithm module includes at least a pair of queues in communication with the event module, for sending classification data to the event module.
